(19) United States
(12) Patent Application Publication
(10) Pub. No.: US 2020/0269412 A1
(43) Pub. Date: Aug. 27, 2020

(54) FLEXIBLE MAGNETIC CUSHION FOR PLACEMENT AND LOCATION OF HAND TOOLS

(71) Applicant: Chih-Chien HSIEH, Taichung City (TW)

(72) Inventor: Chih-Chien HSIEH, Taichung City (TW)

(21) Appl. No.: 16/281,553

(22) Filed: Feb. 21, 2019

(51) Int. Cl. B25H 3/00; B32B 3/26; B32B 5/32

(52) U.S. Cl. CPC B25H 3/00; B32B 3/266; B32B 2439/02; B32B 2266/0235; B32B 5/32

(57) ABSTRACT

A flexible magnetic cushion for placement and location of hand tools has a magnetic body holding layer composed of flexible sheet material with a first surface and a second surface, as well as a plurality of holding parts distributed separately. The holding parts are provided for holding magnetic bodies. A first surface layer with a first rough surface on the appearance surface is composed of flexible sheet materials which are overlapped on the first surface of magnetic body holding layer. A second surface layer with a second rough surface on the appearance surface is composed of flexible sheet materials which are overlapped on the second surface of magnetic body holding layer. The thickness of magnetic body holding layer is larger than the thickness of the first surface layer and that of the second surface layer.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates generally to a product structure with magnetic adsorption function, and more particularly to an innovative flexible magnetic cushion for adsorptive location when placing hand tools.

### 2. Description of Related Art Including Information Disclosed Under 37 CFR 1.97 and 37 CFR 1.98

For machine assembly, vehicle maintenance and repair, water and other industries, considerable tools are sometimes used in the course of work. Therefore, the placement of tools after use has become a problem.

As stated above, some tool rack structures have been developed, most of which are sleeve tool placement types, the structural type design thereof usually has a rigid holder, the holder has a rail for sliding assembly of several sleeve joint blocks, and the holder is provided with a magnetic part to optionally adsorb to the surface of magnetic metal objects (e.g. engine hood, iron frame, metal cabinet), so as to provide the user with a temporary place for placing tools conveniently.

However, there are still some problems in practical experience of this known structural type. For example, there must be limitations of insert fit accuracy between the sleeve joint block of said holder rail and sleeve tool, which is to say, when the user is placing the sleeve tool, the sleeve tool must be aligned with sleeve joint block accurately, so as to implement insert location, leading to inconvenient placement. In addition, when the rigid holder adsorbs to some objects with a curved surface, the integrated state is unstable. Thus, the convenience of the known tool racks still mismatches the practical requirements.

### BRIEF SUMMARY OF THE INVENTION

The primary object of the present invention is to provide a flexible magnetic cushion for placement and location of hand tools. The technical problem to be solved is to break through how to develop a new type of magnetic cushion structure with more ideal practicability.

Based on said object, the technical characteristic of problem solving of the present invention is that said flexible magnetic cushion for placement and location of hand tools comprises a magnetic body holding layer, composed of flexible sheet materials, the magnetic body holding layer has a first surface and a second surface, as well as a plurality of holding parts distributed separately, the holding parts are provided for holding magnetic bodies; a first surface layer, composed of flexible sheet materials which are overlapped on the first surface of magnetic body holding layer, and the outer surface is a first rough surface; a second surface layer, composed of flexible sheet materials which are overlapped on the second surface of magnetic body holding layer, and the outer surface is a second rough surface; and the thickness of magnetic body holding layer is larger than the thickness of the first surface layer and that of the second surface layer.

In terms of the main effect and merits of the present invention, due to the separately distributed magnetic bodies of the magnetic body holding layer and the morphological feature of wide magnetic face formed on the first and second surface layers, the placement of hand tools in the flexible magnetic cushion is free from the limitations of insert fit accuracy, the tools can be placed in any position and adsorbed quickly, so that the hand tools can be placed more conveniently, meeting the consumers' diversified requirements for placement and location of hand tools better, there is practical progressiveness.

Another object of the present invention is to prevent the hand tools from rolling randomly during placement by another main morphological feature that the appearance surface of the first and second surface layers is set as a rough surface, so as to enhance the placement firmness.

The third object of the present invention is to adsorb the flexible magnetic cushion not only on a planar object, but also on a curved object by the main morphological feature that said flexible magnetic cushion is flexible, so as to implement the practical progressiveness of adhering to the object firmly.

### BRIEF DESCRIPTION OF THE SEVERAL VIEWS OF THE DRAWINGS

FIG. 1 is an exploded view of the preferred embodiment of the present invention.

FIG. 2 is a combined stereogram of the preferred embodiment of the present invention.

FIG. 3 is a top view of the preferred embodiment of the present invention.

FIG. 4 is a broken-out section view of 4-4 in FIG. 3.

FIG. 5 is a schematic diagram of overlapped magnetic fields of adjacent magnetic bodies of the present invention.

FIG. 6 is a schematic diagram of the present invention adsorbed to a curved object.

FIG. 7 is a stereogram of another embodiment of the flexible magnetic cushion form.

FIG. 8 is a front view of folded state of the embodiment disclosed in FIG. 7.

FIG. 9 is a side view of folded state of the embodiment disclosed in FIG. 7 (note: partial section view).

FIG. 10 is an enlarged view of Region B in FIG. 9.

### DETAILED DESCRIPTION OF THE INVENTION

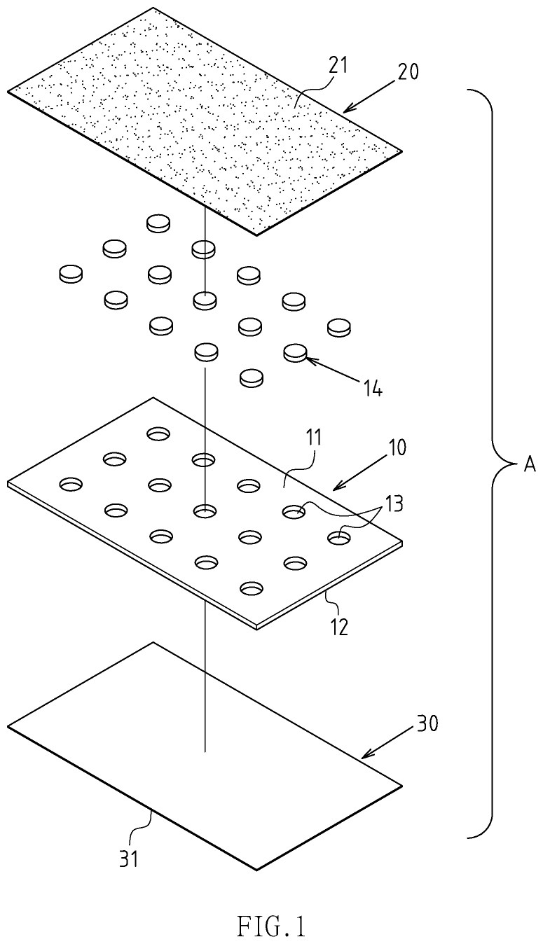

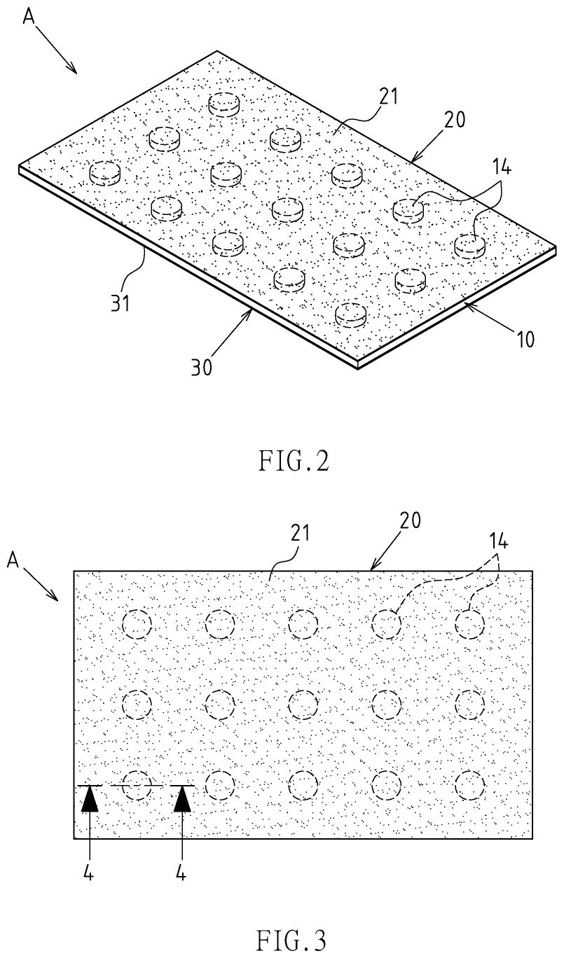

FIGS. 1 to 4 show the preferred embodiments of the flexible magnetic cushion for placement and location of hand tools of the present invention, but the embodiments are for illustration only, the patent application is not limited to this structure.

Said flexible magnetic cushion A comprises a magnetic body holding layer 10, composed of flexible sheet materials, the magnetic body holding layer 10 has a first surface 11 and a second surface 12, and the magnetic body holding layer 10 is provided with a plurality of holding parts 13 distributed separately, each of the holding parts 13 is provided for holding a magnetic body 14 (note: strong magnet is preferred); a first surface layer 20, composed of flexible sheet materials, the first surface layer 20 is overlapped on the first surface 11 of the magnetic body holding layer 10, and the appearance surface of the first surface layer 20 has a first rough surface 21; a second surface layer 30, composed of flexible sheet materials, the second surface layer 30 is overlapped on the second surface 12 of the magnetic body holding layer 10, and the appearance surface of the second surface layer 30 has a second rough surface 31; wherein the thickness of the magnetic body holding layer 10 is larger than the thickness of the first surface layer 20 and that of the second surface layer 30. The holding parts 13 of the magnetic body holding layer 10 are grooves or through holes.

The first surface layer 20 and the second surface layer 30 are composed of PVC expanded material, the magnetic body holding layer 10 is composed of EVA expanded material. The first surface layer 20 and the second surface layer 30 adhere to the magnetic body holding layer 10 (not limited to glue, double sticky tapes or inert adhesives).

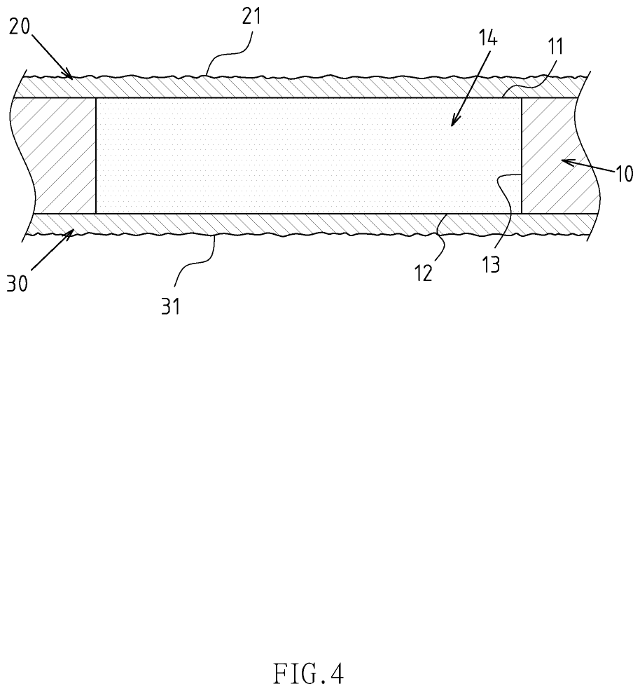

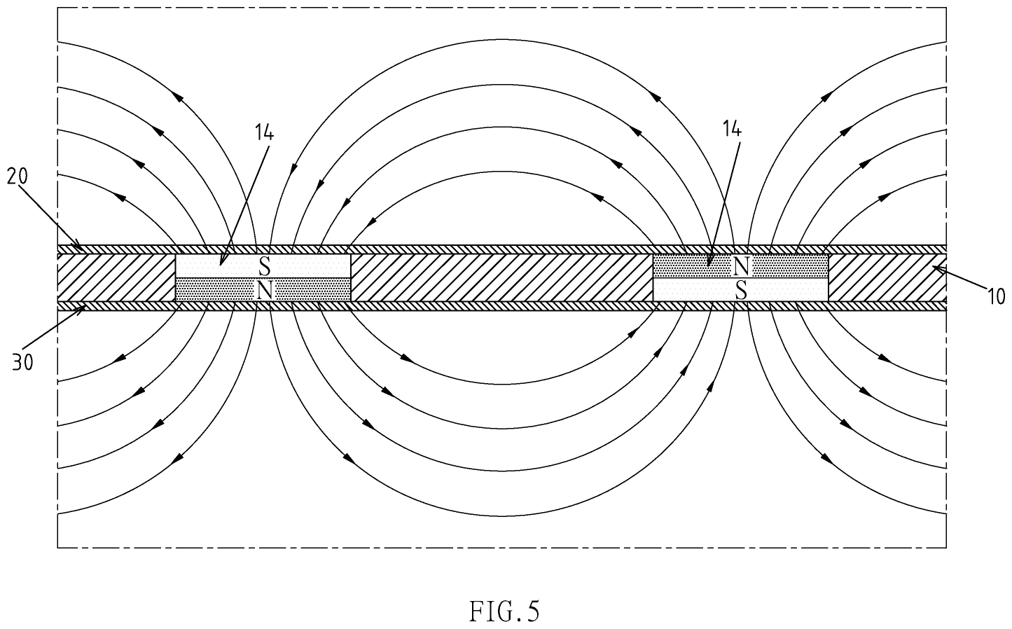

As shown in FIG. 4, in this case, the first rough surface 21 is integrated with the structural material of the first surface layer 20, the second rough surface 31 is integrated with the structural material of the second surface layer 30; the purpose of said integrated first rough surface 21 and second rough surface 31 in this case is that the rough surface is easy to clean and relatively durable (note: the present invention can use sand grain surface, floss surface or surface coating to form the rough surface, but this kind of rough surface form will flake off in the future, it is unserviceable).

Based on said structure type and technical characteristics, in practical application of the flexible magnetic cushion for placement and location of hand tools disclosed in the present invention, through the simple structural composition of magnetic body holding layer 10, the first surface layer 20 and the second surface layer 30 (as shown in FIGS. 1 to 4), when a user is to use a hand tool (e.g. sleeve, pincers or spanner), the flexible magnetic cushion A can be adsorbed to the magnetoconductive surface of an object (e.g. iron cabinet, iron frame or engine hood) near the work site, so as to form a wide magnetic attraction positioning plane by using the first rough surface 21 or the second rough surface 31, the user can place the hand tool on the first rough surface 21 or the second rough surface 31 of the flexible magnetic cushion A quickly at will, and then it is fixed firmly, free of the insert fit accuracy problem in the known placement of hand tools, the hand tools can be placed more conveniently, and the work is smoother.

As shown in FIG. 5, in this case, the distance between adjacent magnetic bodies 14 must result in overlapped magnetic fields; this is the preferred embodiment of magnetic bodies 14 of the present invention, the merit is that when the user is placing the hand tool, no matter whether the placement is aligned with the magnetic body 14 exactly or not, there is magnetic attraction effect due to said overlapped magnetic fields.

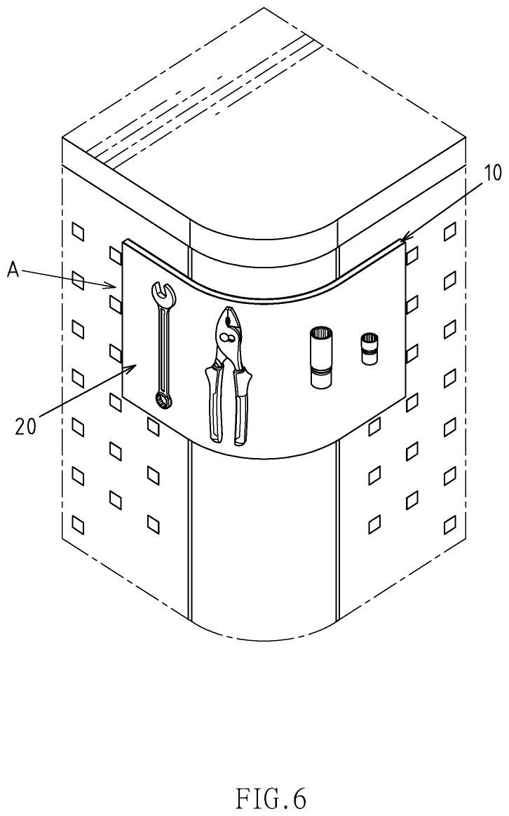

As shown in FIG. 6, the flexible magnetic cushion A is composed of flexible sheet material, so it is not limited to planar objects, it can adsorb to curved objects (e.g. metal cabinet corner parts or engine hood).

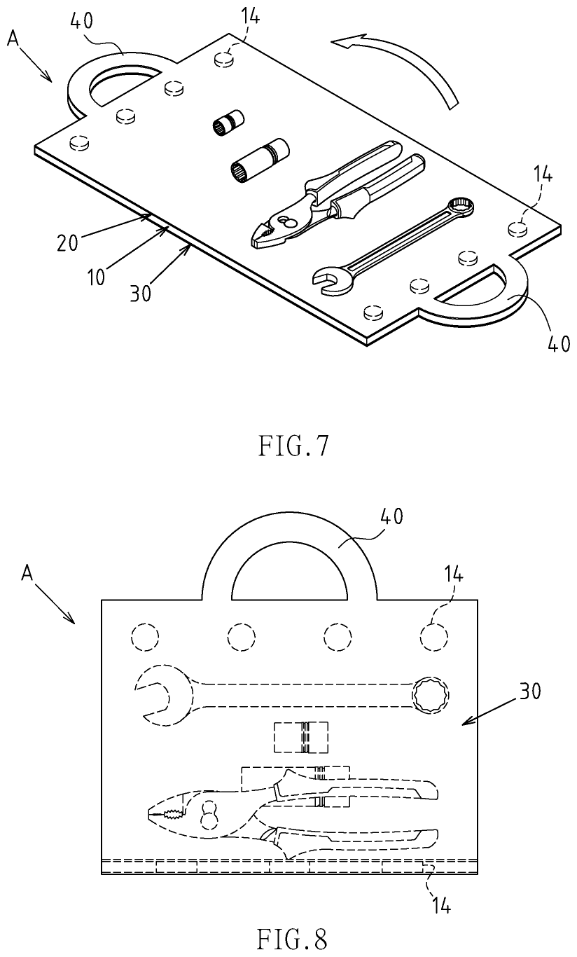

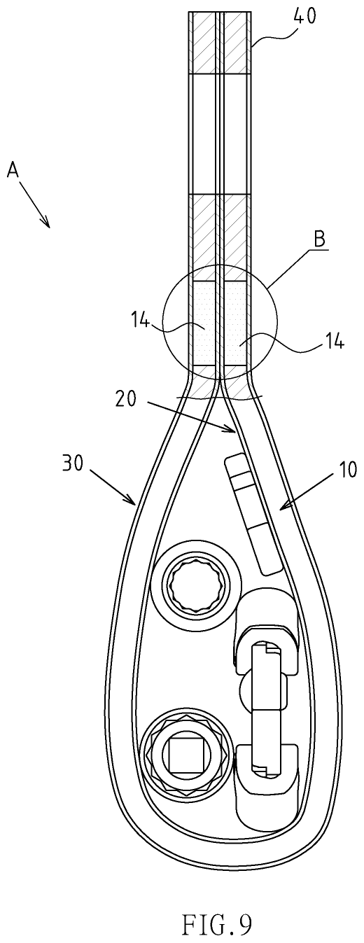

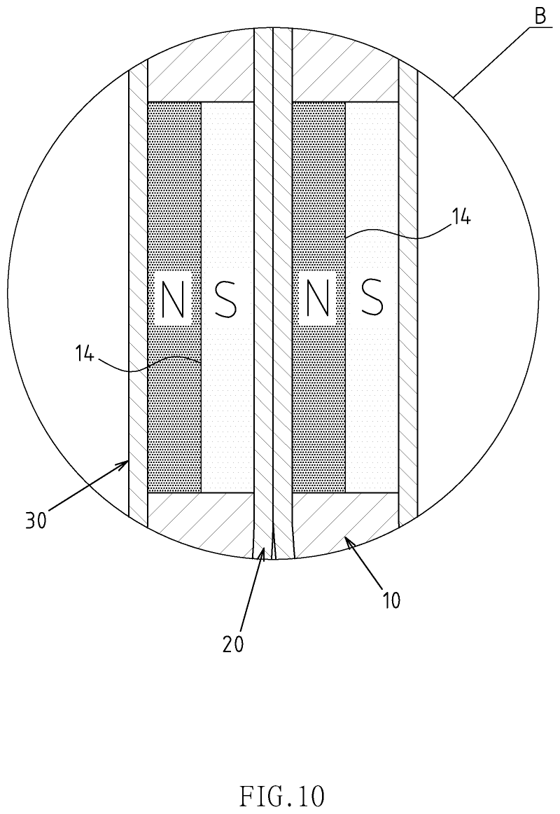

As shown in FIGS. 7˜10, in this case, the symmetrical different magnetic bodies 14 located on two oppositely distant sides of the magnetic body holding layer 10 have attractive poles, when the flexible magnetic cushion A is folded, the two sides contacting each other are located by the attractive poles of said different magnetic bodies 14 (as shown in FIG. 10). The purpose of said magnetic body holding layer 10 in this case is to make the flexible magnetic cushion A a bag (as shown in FIGS. 8, 9), and the storage region can store magnetic objects and non-magnetic objects, and the volume of the flexible magnetic cushion A can be reduced.

As shown in FIG. 8, in the embodiment, a carrying handle 40 extends outwards from the two oppositely distant sides of the magnetic body holding layer 10 respectively, when the flexible magnetic cushion A is folded, the carrying handles 40 on the two sides are overlapped to form one carrying handle 40. Said carrying handle 40 in this case aims at convenient carrying.

I claim:

1. A flexible magnetic cushion for placement and location of hand tools, the flexible magnetic cushion comprises:
a magnetic body holding layer, composed of flexible sheet material, the magnetic body holding layer has a first surface and a second surface, and the magnetic body holding layer is provided with a plurality of holding parts distributed separately, each of the holding parts is provided for holding a magnetic body;
a first surface layer, composed of flexible sheet material, the first surface layer is overlapped on the first surface of the magnetic body holding layer, and the appearance surface of the first surface layer has a first rough surface; and
a second surface layer, composed of flexible sheet material, the second surface layer is overlapped on the second surface of the magnetic body holding layer, and the appearance surface of the second surface layer has a second rough surface;
and the thickness of the magnetic body holding layer is larger than the thickness of the first surface layer and that of the second surface layer.

2. The flexible magnetic cushion for placement and location defined in claim 1, wherein the distance between adjacent magnetic bodies must result in overlapped magnetic fields.

3. The flexible magnetic cushion for placement and location defined in claim 2, wherein the first rough surface is integrated with the structural material of the first surface layer, the second rough surface is integrated with the structural material of the second surface layer.

4. The flexible magnetic cushion for placement and location defined in claim 3, wherein the symmetrical different magnetic bodies located on two oppositely distant sides of the magnetic body holding layer have attractive poles, when the flexible magnetic cushion is folded, the two sides contacting each other are located by the attractive poles of said different magnetic bodies.

5. The flexible magnetic cushion for placement and location defined in claim 4, wherein a carrying handle extends outwards from the two oppositely distant sides of the magnetic body holding layer respectively, when the flexible magnetic cushion is folded, the carrying handles on the two sides are overlapped to form one carrying handle.

6. The flexible magnetic cushion for placement and location defined in claim 5, wherein the holding parts of the magnetic body holding layer are grooves or through holes.

7. The flexible magnetic cushion for placement and location defined in claim 6, wherein the first surface layer and the second surface layer are composed of PVC expanded material, the magnetic body holding layer is composed of EVA expanded material.

8. The flexible magnetic cushion for placement and location defined in claim 7, wherein the first surface layer, the second surface layer and the magnetic body holding layer adhere to each other.
